(19) United States
(12) Patent Application Publication
(10) Pub. No.: US 2023/0366420 A1
(43) Pub. Date: Nov. 16, 2023

(54) SERVICEABLE STUD AND GROMMET ASSEMBLY WITH LOW INSTALLATION EFFORT AND HIGH EXTRACTION FORCE

(71) Applicant: Newfrey LLC, New Britain, CT (US)

(72) Inventors: Aaron J. Smith, Hazel Park, MI (US); Andrew C. Heidacker, Commerce Township, MI (US); Hunter Soles, Royal Oak, MI (US)

(73) Assignee: Newfrey LLC, New Britain, CT (US)

(21) Appl. No.: 18/133,859

(22) Filed: Apr. 12, 2023

Related U.S. Application Data
(60) Provisional application No. 63/341,868, filed on May 13, 2022.

(51) Int. Cl. F16B 5/06; F16B 19/10

(52) U.S. Cl. CPC F16B 5/0621; F16B 19/1081

(57) ABSTRACT

A grommet is configured to be fixed within a hole in a panel and to receive a stud to couple the stud to the panel. The grommet includes a hollow body having an inner surface and an outer surface, a flange disposed at one end of the hollow body, panel retention fingers protruding from the outer surface of the hollow body, and stud retention fingers protruding from the inner surface of the hollow body. The panel retention fingers are configured to engage a bottom surface of the panel when the grommet is fully inserted into the hole in the panel. The stud retention fingers are configured to engage an underside surface of the head of the stud when the stud is fully inserted into the hole in the grommet.

### CROSS-REFERENCE TO RELATED APPLICATIONS

This application claims the benefit of U.S. Provisional Application No. 63/341,868, filed on May 13, 2022. The entire disclosure of the application referenced above is incorporated herein by reference.

### FIELD

The present disclosure relates to a serviceable stud and grommet assembly with low installation effort and high extraction force.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Stud and grommet assemblies are used to attach a vehicle component, such as a trim panel, to a vehicle body structure, such as a lift gate. A stud and grommet assembly typically includes a stud and a grommet. The stud is coupled to the vehicle component to be attached. The grommet is inserted into a hole in the vehicle body structure and is secured to a flange of the vehicle body structure defining the hole.

The grommet typically includes a tubular body with interference bumps disposed on the radially inner and outer surfaces thereof. The grommet is fixed within the hole in the vehicle body structure by inserting the grommet into the hole until the bumps on the outer surface of the tubular body move past the flange of the vehicle body structure and engage the backside thereof. The stud is secured to the grommet by inserting a head of the stud into the tubular body of the grommet until the head moves past the bumps on the inner surface of the tubular body, which engage the backside of a portion of the head that projects radially outward from the remainder of the stud.

Stud and grommet assemblies with interference bumps typically have high insertion forces because the tubular body of the grommet must flex radially inward to allow the bumps on the outer surface thereof to move past the flange of the vehicle body structure. In addition, such assemblies typically have low retraction forces because the stud can be withdrawn from the grommet by overcoming only slight resistance due to the engagement between the bumps on the inner surface of the grommet and the backside of the head of the stud.

### SUMMARY

An example of a grommet according to the present disclosure is configured to be fixed within a hole in a panel and to receive a stud to couple the stud to the panel. In one example, the grommet includes a hollow body having an inner surface and an outer surface, a flange disposed at one end of the hollow body, panel retention fingers protruding from the outer surface of the hollow body, and stud retention fingers protruding from the inner surface of the hollow body. The panel retention fingers are configured to flex toward the outer surface of the hollow body when the hollow body is inserted into the hole in the panel. The panel retention fingers are configured to flex away from the hollow body and engage a bottom surface of the panel when the grommet is fully inserted into the hole in the panel. The stud retention fingers are configured to flex toward the inner surface of the hollow body when a head of the stud is inserted into the hole in the grommet. The stud retention fingers are configured to flex away from the hollow body and engage an underside surface of the head of the stud when the stud is fully inserted into the hole in the grommet.

In one aspect, the grommet is formed as a unitary body.

In one aspect, the hole in the grommet extends completely through the grommet.

In one aspect, the flange of the grommet defines openings that are aligned with the panel retention fingers about a perimeter of the hollow body.

In one aspect, the outer surface of the hollow body defines recesses configured to receive the panel retention fingers when the panel retention fingers flex toward the outer surface, and the inner surface of the hollow body defines recesses configured to receive the stud retention fingers when the stud retention fingers flex toward the inner surface.

In one aspect, the panel retention fingers flex about hinges disposed at or near a connection between the panel retention fingers and the hollow body and formed integral therewith, and the stud retention fingers flex about hinges disposed at or near a connection between the stud retention fingers and the hollow body and formed integral therewith.

In one aspect, the panel retention fingers define teeth configured to engage the bottom surface of the panel and thereby maintain the grommet in a fixed position within the hole in the panel.

In one aspect, the stud retention fingers have ramped surfaces at distal ends thereof.

In one aspect, portions of the hollow body form guide walls having tapered surfaces that engage the stud and thereby coaxially align the stud with the hole of the grommet as the stud is inserted therein.

An example of a stud and grommet assembly according to the present disclosure includes the grommet and the stud, where the stud is configured to be coupled to a component so that the stud and grommet assembly couples the component to the panel when the stud is received in the hole in the grommet and the grommet is fixed within the hole in the panel.

In one aspect, the stud includes a cylindrical body, at least one flange projecting radially outward from the cylindrical body, and the head, and the head is disposed at one end of the cylindrical body.

In one aspect, the at least one flange of the stud includes a pair of flanges that define a gap therebetween for receiving a flange of the component surrounding the hole therein.

In one aspect, the stud includes an umbrella-shaped flange projecting from the flange of the stud closest to the head and configured to seal against the panel when the stud is fully inserted in the hole in the grommet and the grommet is fixed within the hole in the panel.

In one aspect, the stud includes a threaded shank disposed at the other end of the cylindrical body and configured to be threaded into a threaded hole in the component to couple the stud to the component, and the flange of the stud has a noncircular perimeter.

In one aspect, the stud includes an umbrella-shaped flange projecting from the noncircular perimeter of the flange of the stud and configured to seal against the panel when the stud is fully inserted in the hole in the grommet and the grommet is fixed within the hole in the panel.

Another example of a stud and grommet assembly according to the present disclosure includes a stud configured to be coupled to a component and a grommet configured to be fixed within a hole in a panel. The stud includes a cylindrical body, at least one flange projecting radially outward from the cylindrical body, and a conical head disposed at one end of the cylindrical body. The grommet includes a tubular body having an inner surface and an outer surface, an annular flange disposed at one end of the tubular body, panel retention fingers protruding from the outer surface of the tubular body, and stud retention fingers protruding from the inner surface of the tubular body. The panel retention fingers are configured to flex radially inward toward the outer surface of the tubular body when the tubular body is inserted into the hole in the panel. The panel retention fingers are configured to flex radially outward away from the tubular body and engage a bottom surface of the panel when the grommet is fully inserted into the hole in the panel so that the annular flange of the grommet engages a top surface of the panel. The stud retention fingers are configured to flex radially outward toward the inner surface of the tubular body when the conical head of the stud is inserted into the hole in the grommet. The stud retention fingers are configured to flex radially inward away from the tubular body and engage an underside surface of the conical head of the stud when the stud is fully inserted into the hole in the grommet so that the at least one flange of the stud engages the annular flange of the grommet.

In one aspect, the hole in the grommet extends completely through the grommet along a central longitudinal axis thereof.

In one aspect, the annular flange of the grommet defines rectangular openings that are each aligned with one of the panel retention fingers about a circumference of the tubular body and disposed above that panel retention finger.

In one aspect, the at least one flange of the stud includes a pair of disk-shaped flanges that define a gap therebetween for receiving a flange of the component surrounding the hole therein.

In one aspect, the stud includes a threaded shank disposed at the other end of the cylindrical body and configured to be threaded into the hole in the component to couple the stud to the component, and a perimeter of the at least one flange has a noncircular shape.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an exploded perspective view of an example stud and grommet assembly according to the present disclosure, the assembly including a stud and a grommet;

FIG. 2 is a perspective view of the grommet of FIG. 1;

FIG. 3 is a sectioned perspective view of the grommet of FIG. 1;

FIG. 4 is a perspective view of the stud and grommet assembly of FIG. 1 secured to a panel;

FIG. 5 is a side view of the stud and grommet assembly of FIG. 1 coupling a component to the panel;

FIG. 6 is a top view of the stud and grommet assembly of FIG. 1;

FIG. 7 is a bottom view of the stud and grommet assembly of FIG. 1;

FIG. 8 is section view of the stud and grommet assembly of FIG. 1 taken along a line 8-8 shown in FIG. 7, the assembly coupling the component to the panel;

FIG. 9 is a perspective view of another example stud and grommet assembly according to the present disclosure secured to a panel, the assembly including a stud and the grommet of FIG. 1;

FIG. 10 is a perspective view of the grommet of FIG. 9;

FIG. 11 is a bottom view of the stud and grommet assembly of FIG. 9;

FIG. 12 is a section view of the stud and grommet assembly of FIG. 9 taken along a line 12-12 shown in FIG. 11, the assembly coupling a component to the panel;

FIGS. 13 and 14 are side views of the grommet of FIG. 1;

FIG. 15 is a side view of the stud of FIG. 9;

FIG. 16 is a perspective view of the stud of FIG. 9;

FIG. 17 is a perspective view of another example stud according to the present disclosure;

FIG. 18 is a perspective view of another example stud and grommet assembly according to the present disclosure including the grommet of FIG. 1 and the stud of FIG. 17;

FIG. 19 is a side view of the stud and grommet assembly of FIG. 18 coupling the component to the panel;

FIG. 20 is a perspective view of another example stud according to the present disclosure;

FIG. 21 is a perspective view of another example stud and grommet assembly according to the present disclosure including the grommet of FIG. 1 and the stud of FIG. 20; and

FIG. 22 is a side view of the stud and grommet assembly of FIG. 21 coupling the component to the panel.

In the drawings, reference numbers may be reused to identify similar and/or identical elements.

### DETAILED DESCRIPTION

In contrast to the stud and grommet assembly discussed above, a stud and grommet assembly according to the present disclosure includes stud retention fingers and panel retention fingers in place of interference bumps on the inner and outer radial surfaces of the grommet, respectively. The panel retention fingers require a lower insertion effort because less force is required to flex the panel retention fingers relative to the force required to flex the tubular body. The stud retention fingers require a higher extraction force because the stud retention fingers wedge against the backside of the head of the stud. In addition, a stud and grommet assembly according to the present disclosure includes various features that enable molding the grommet as a unitary body that includes both the stud retention fingers and the panel retention fingers. Furthermore, a stud and grommet assembly according to the present disclosure provides more repeatability and robustness than conventional stud and grommet assemblies.

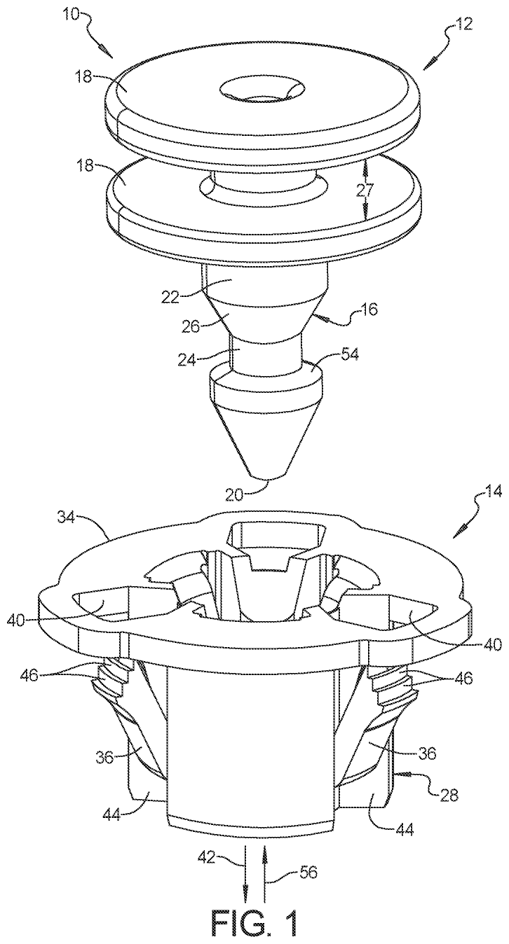

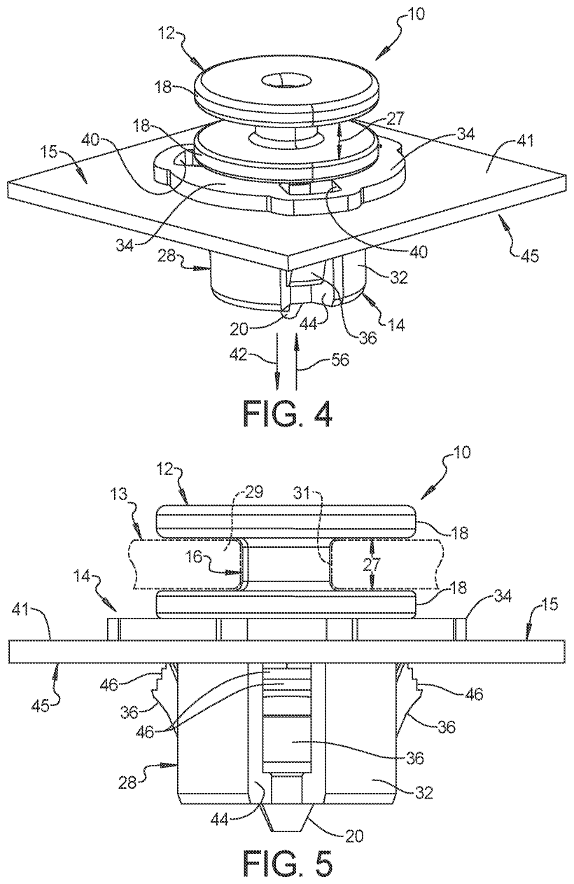

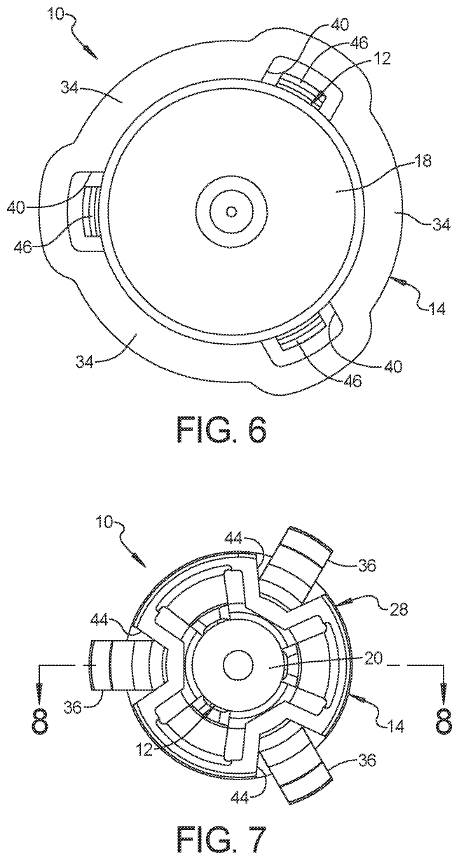

Referring now to FIGS. 1 through 8, a stud and grommet assembly 10 includes a stud 12 and a grommet 14. The stud 12 can be coupled to a component 13 (FIG. 5), such as a light fixture (not shown), to be attached to a panel 15 (FIGS. 4 and 5) such as a body panel of a vehicle. The grommet 14 can be fixed within a hole 17 in the panel 15. Thus, the stud and grommet assembly 10 can be used as an assembly aid to attach the component 13 to the panel 15.

The stud 12 includes a cylindrical body 16, a pair of disk-shaped flanges 18 projecting radially outward from the cylindrical body 16, and a conical head 20 disposed at one end of the cylindrical body 16. The cylindrical body 16 of the stud 12 includes a first portion 22 having a first diameter D1 (FIG. 15), a second portion 24 having a second diameter D2 (FIG. 15) that is less than the first diameter D1, and a third portion 26 having a conical shape that transitions from the first diameter D1 to the second diameter D2. The stud 12 may be made from plastic. In one example, the cylindrical body 16 of the stud 12 is made from a first material (e.g., acetal) in a first molding shot, and the remainder of the stud 12 is made from a second material (e.g., thermoplastic elastomer) in a second molding shot.

The disk-shaped flanges 18 of the stud 12 define a gap 27 therebetween for receiving an annular flange 29 of the component 13 surrounding a hole 31 therein. The annular flange 29 on the component 13 may be referred to as a doghouse flange. The diameter of the hole 31 in the component 13 may be greater than the first diameter D1 of the first portion 22 of the stud 12 and less than the diameter of the disk-shaped flanges 18. To couple the stud 12 to the component 13, the disk-shaped flange 18 furthest away from the conical head 20 may be inserted through the hole 31 in the component 13. The annular flange 29 on the component 13 may be flexible to enable insertion of the disk-shaped flange 18 through the hole 31 in the component 13.

The grommet 14 includes a hollow tubular body 28 having an inner surface 30 and an outer surface 32, an annular flange 34 disposed at one end of the tubular body 28, panel retention fingers 36 protruding from the outer surface 32 of the tubular body 28, and stud retention fingers 38 protruding from the inner surface 30 of the tubular body 28. The grommet 14 may be made from plastic. The annular flange 34 defines rectangular openings 40 to facilitate molding the panel retention fingers 36 with the remainder of the grommet 14 as a unitary body. Each rectangular opening 40 is aligned with one of the panel retention fingers 36 about the perimeter or circumference of the tubular body 28 and is disposed above that panel retention finger 36. Each rectangular opening 40 is sized to allow a mold cavity for one of the panel retention fingers 36 to be moved therethrough.

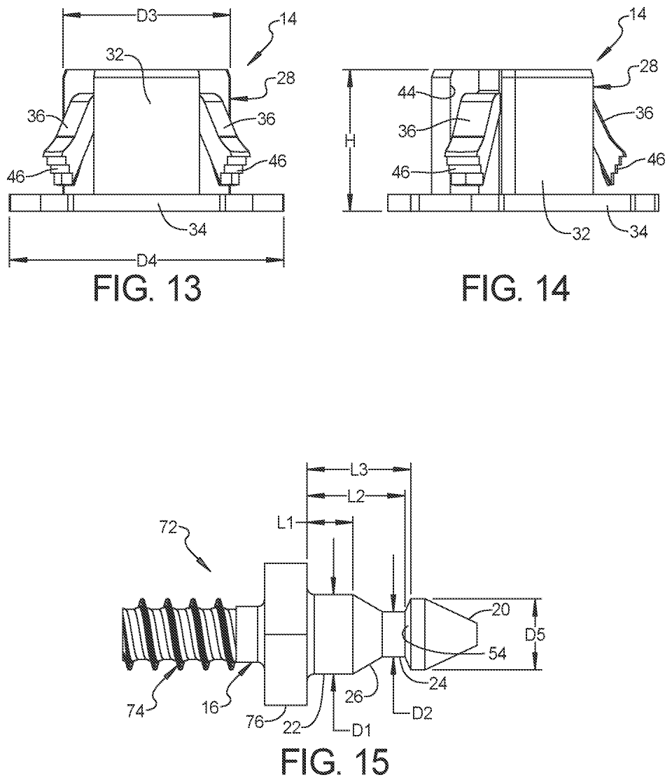

To couple the grommet 14 to the panel 15, the tubular body 28 of the grommet 14 is inserted in a first direction 42 (FIG. 1) into the hole 17 in the panel 15 until the annular flange 34 engages the panel 15. The first direction 42 is perpendicular to top and bottom surfaces 41 and 45 of the panel 15. The diameter of the hole 17 in the panel 15 may be greater than a diameter D3 (FIG. 13) of the tubular body 28 and less than a diameter D4 (FIG. 13) of the annular flange 34.

As the grommet 14 is inserted into the hole 17 in the panel 15, the portion of the panel 15 defining the hole 17 therein engages the panel retention fingers 36 and thereby causes the fingers 36 to flex about a hinge 43 radially inward toward the outer surface 32 of the tubular body 28. Each hinge 43 is disposed at or near the connection between one of the panel retention fingers 36 and the tubular body 28 and is formed integral therewith. The hinge 43 may be referred to as a living hinge or integral hinge.

Each panel retention finger 36 may flex radially inward into a recess 44 in the outer surface 32 of the tubular body 28 as the grommet 14 is inserted into the hole 17 in the panel 15. When the grommet 14 is fully inserted into the hole 17 in the panel 15 so that the annual flange 34 engages the top surface 41 of the panel 15, the panel retention fingers 36 flex about the hinge 43 away from the tubular body 28 of the grommet 14 and return their relaxed state (shown). In turn, the panel 15 is captured between the annular flange 34 and the panel retention fingers 36. Each panel retention fingers 36 may define one or more teeth 46 at a distal end thereof that engage the bottom surface 45 of the panel 15 and thereby maintain the grommet 14 in a fixed position within the hole 17 in the panel 15.

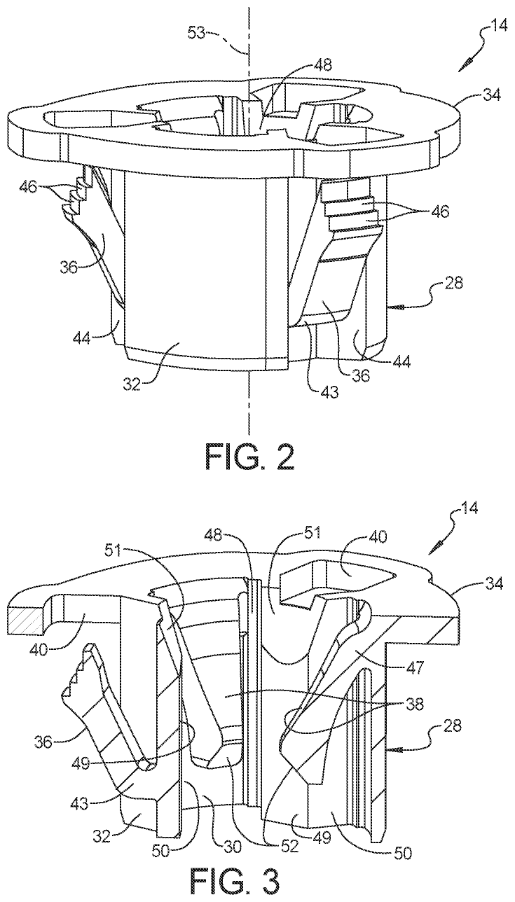

To couple the stud 12 to the grommet 14, the cylindrical body 16 of the stud 12 and the head 20 of the stud 12 are inserted in the first direction 42 into a hole 48 in the grommet 14 until the disk-shaped flange 18 closest to the head 20 engages the annular flange 34 on the grommet 14. The hole 48 in the grommet 14 is defined by the inner surface 30 thereof and extends along a central longitudinal axis 53 (FIG. 2) of the grommet 14. As best shown in FIG. 3, the hole 48 extends completely through the grommet 14, including through the bottom end thereof, which provides access to the underside of the grommet 14 for forming the stud retention fingers 38 with the remainder of the grommet 14 as a unitary body.

As the head 20 of the stud 12 is inserted into the hole 48 in the grommet 14, the head 20 engages the stud retention fingers 38 and thereby cause the fingers 38 to flex about a hinge 47 toward the inner surface 30 of the tubular body 28 of the grommet 14. Each hinge 47 is disposed at or near the connection between one of the stud retention fingers 38 and the tubular body 28 and is formed integral therewith. The hinge 47 may be referred to as a living hinge or integral hinge.

Portions 49 of the tubular body 28 of the grommet 14 may form guide walls having tapered surfaces 51 that engage the cylindrical body 16 of the stud 12 and thereby coaxially align the stud 12 with the hole 48 of the grommet 14 as the stud 12 is inserted therein. Each stud retention finger 38 may flex radially outward into a recess 50 in the inner surface 30 of the tubular body 28 as the head 20 of the stud 12 is inserted into the hole 48 in the grommet 14. The portions 49 of the tubular body 28 of the grommet 14 that form the guide walls are disposed between the recesses 50 in the inner surface 30 of the tubular body 38.

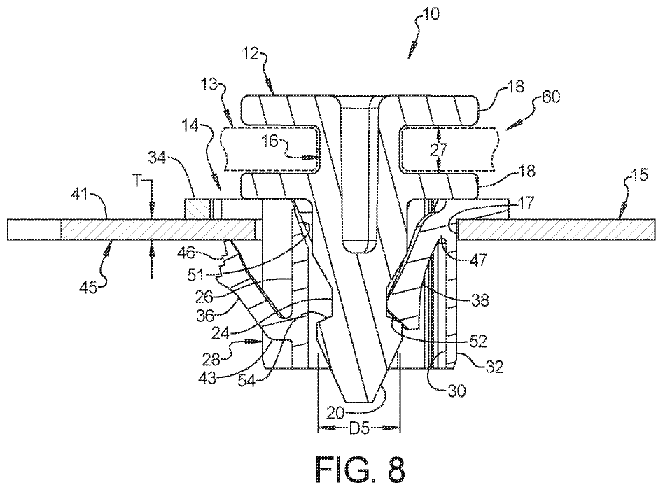

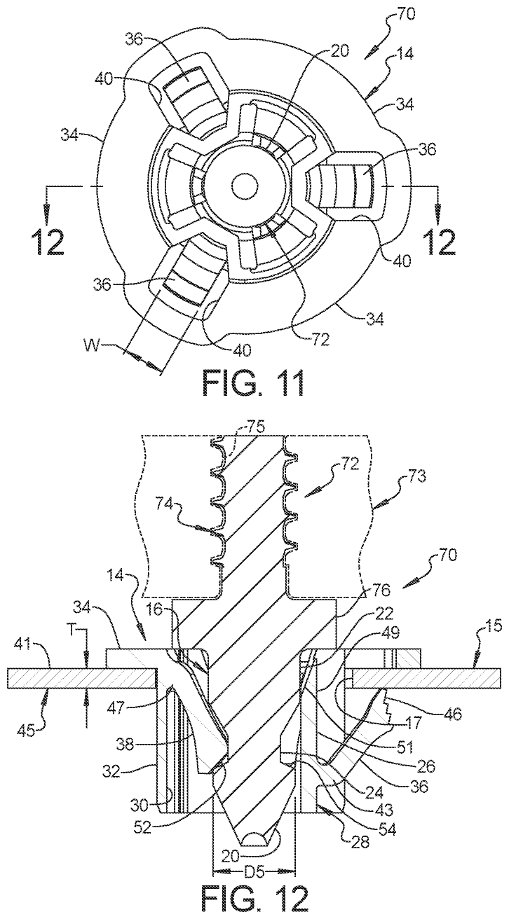

When the stud 12 is fully inserted into the hole 48 in the grommet 14 so that disk-shaped flange 18 closest to the head 20 engages the annular flange 34 of the grommet 14 as best shown in FIG. 8, the stud retention fingers 38 flex about the hinge 47 away from the inner surface 30 of the tubular body 28 and return their relaxed state (shown). In turn, end surfaces 52 disposed at the distal ends of the stud retention fingers 38 engage an underside surface 54 of the head 20 of the stud 12 to retain the head 20 within the hole 48 in the grommet 14 and thereby secure the stud 12 to the grommet 14 as shown in FIG. 11. The end surfaces 52 of the stud retention fingers 38 may be ramped as shown to enable extracting the stud 12 from the grommet 14 by pulling on the stud 12 in a second direction 56 (FIG. 1) opposite of the first direction 42. In turn, the component 13 coupled to the panel 15 using the stud and grommet assembly 10 may be detached from the panel 15 and repaired or replaced.

In FIGS. 4, 5, and 8, the stud and grommet assembly 10 is shown with the panel 15 clamped between the panel retention fingers 36 of the grommet 14 and the annular flange 34 of the grommet 14. In addition, the stud 12 is fully inserted into the hole 48 in the grommet 14. In FIGS. 5 and 8, the annular flange 29 of the component 13 is captured between the disk-shaped flanges 18 of the stud 12, and therefore the stud and grommet assembly 10 is coupling the component 13 to the panel 15.

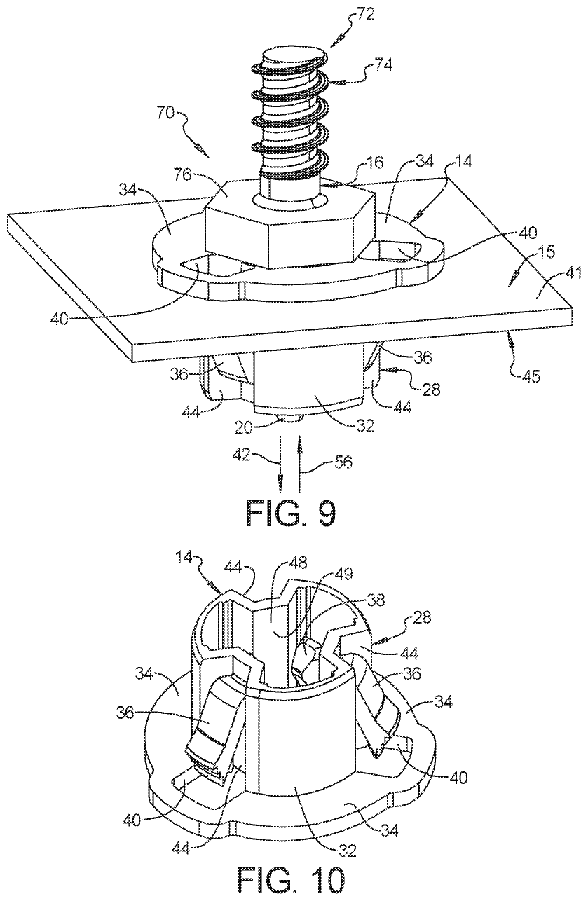

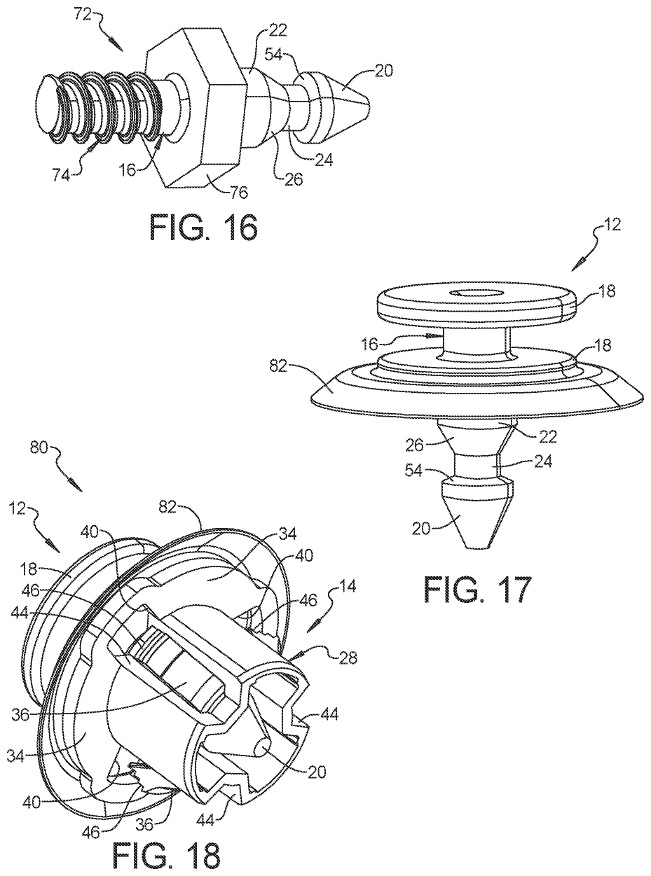

Referring now to FIGS. 9 through 16, a stud and grommet assembly 70 is shown that is similar or identical to the stud and grommet assembly 10 shown in FIGS. 1 through 8 except that the stud 12 is replaced with a stud 72. The stud 72 can be coupled to a component 73, such as a light fixture (not shown), to be attached to the panel 15. In FIG. 9, the stud and grommet assembly 70 is shown with the panel 15 clamped between the panel retention fingers 36 of the grommet 14 and the annular flange 34 of the grommet 14. The stud 72 may be referred to as a gari-ball stud. The stud 72 may be made from metal.

The grommet 14 has a height H, the panel 15 has a thickness T (FIG. 12), and each stud retention finger 36 has a width W (FIG. 11). The first portion 22 of the stud 12 has a first length L1 (FIG. 15). The first, second, and third portions 22, 24, and 26 of the cylindrical body 16 of the stud 12 collectively have a second length L2 (FIG. 15). The first, second, and third portions 22, 24, and 26 of the cylindrical body 16 of the stud 12 and the underside surface 54 of the head 20 of the stud 12 collectively have a third length L3 (FIG. 15).

As best shown in FIGS. 12, 15, and 16, the stud 72 includes the cylindrical body 16, a threaded shank 74 disposed at one end of the cylindrical body 16, the conical head 20 disposed at the other end of the cylindrical body 16, and a hexagonal flange 76 projecting radially outward from the cylindrical body 16. To couple the stud 72 to the component 73, the threaded shank 74 of the stud 72 may be threaded into a threaded hole 75 in the component 73 by, for example, placing a wrench onto the hexagonal flange 76 of the stud 72. The perimeter of the flange 76 may have a noncircular shape other than hexagonal, such as square or pentagonal. The stud 72 may be coupled to the grommet 14 in the same way that the stud 12 is coupled to the grommet 14.

Referring now to FIGS. 17 through 19, a stud and grommet assembly 80 is shown that is similar or identical to the stud and grommet assembly 10 shown in FIGS. 1 through 8 except that the stud 12 includes an umbrella-shaped flange 82 projecting radially outward from the disk-shaped flange 18 closest to the head 20. As discussed above, the annular flange 34 of the grommet 14 defines the rectangular openings 40 and the inner surface 30 of the grommet 14 defines the hole 48 to facilitate molding the grommet 14 as a unitary body. The rectangular openings 40 and the hole 48 in the grommet 14 permit moisture to pass through the stud and grommet assembly 10.

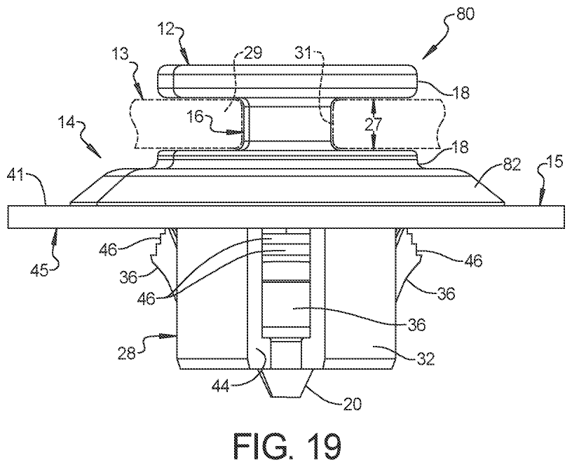

When the stud 12 is fully inserted into the hole 48 in the grommet 14 as shown in FIGS. 18 and 19 and the grommet 14 is fully inserted into the hole 17 in the panel 15 as shown in FIG. 19, the umbrella-shaped flange 82 presses against the top surface 41 of the panel 15. In turn, the umbrella-shaped flange 82 creates a seal with the top surface 41 of the panel 15 and thereby prevents moisture flow from the rectangular openings 40 and the hole 48 in the grommet 14 to the hole 31 in the component 13.

The umbrella-shaped flange 82 may be formed with the remainder of the stud 12 as a unitary body. The umbrella-shaped flange 82 may be made from a material that is sufficiently flexible to create a seal with the top surface 41 of the panel 15 despite manufacturing variations in the geometry of the top surface 41 and/or the umbrella-shaped flange 82. In one example, the cylindrical body 16 of the stud 12 is made from a first material (e.g., acetal) in a first molding shot, and the remainder of the stud 12 (including the umbrella-shaped flange 82) is made from a second material (e.g., thermoplastic elastomer) in a second molding shot.

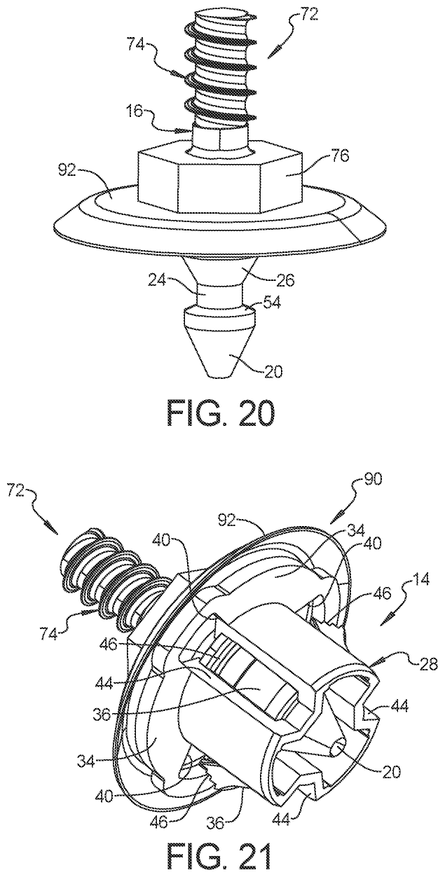

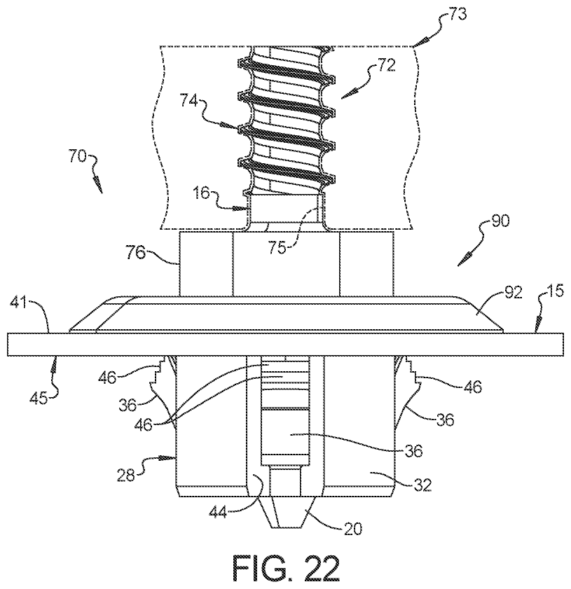

Referring now to FIGS. 20 through 22, a stud and grommet assembly 90 is shown that is similar or identical to the stud and grommet assembly 10 shown in FIGS. 9 through 16 except that the stud 72 includes an umbrella-shaped flange 92 projecting radially outward from the hexagonal flange 76. When the stud 72 is fully inserted into the hole 48 in the grommet 14 as shown in FIGS. 21 and 22 and the grommet 14 is fully inserted into the hole 17 in the panel 15 as shown in FIG. 22, the umbrella-shaped flange 92 presses against the top surface 41 of the panel 15. In turn, the umbrella-shaped flange 92 creates a seal with the top surface 41 of the panel 15 and thereby prevents moisture flow from the rectangular openings 40 and the hole 48 in the grommet 14 to the threaded hole 75 in the component 73.

The umbrella-shaped flange 92 may be formed with the remainder of the stud 72 as a unitary body. The umbrella-shaped flange 92 may be made from a material that is sufficiently flexible to create a seal with the top surface 41 of the panel 15 despite manufacturing variations in the geometry of the top surface 41 and/or the umbrella-shaped flange 92. In one example, the cylindrical body 16 of the stud 72 is made from a first material (e.g., acetal) in a first molding shot, and the remainder of the stud 72 (including the umbrella-shaped flange 92) is made from a second material (e.g., thermoplastic elastomer) in a second molding shot.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A grommet configured to be fixed within a hole in a panel and to receive a stud to couple the stud to the panel, the grommet comprising:
a hollow body having an inner surface and an outer surface;
a flange disposed at one end of the hollow body;
panel retention fingers protruding from the outer surface of the hollow body; and
stud retention fingers protruding from the inner surface of the hollow body, wherein:
the panel retention fingers are configured to flex toward the outer surface of the hollow body when the hollow body is inserted into the hole in the panel;
the panel retention fingers are configured to flex away from the hollow body and engage a bottom surface of the panel when the grommet is fully inserted into the hole in the panel;
the stud retention fingers are configured to flex toward the inner surface of the hollow body when a head of the stud is inserted into the hole in the grommet; and
the stud retention fingers are configured to flex away from the hollow body and engage an underside surface of the head of the stud when the stud is fully inserted into the hole in the grommet.

2. The grommet of claim 1 wherein the grommet is formed as a unitary body.

3. The grommet of claim 1 wherein the hole in the grommet extends completely through the grommet.

4. The grommet of claim 1 wherein the flange of the grommet defines openings that are aligned with the panel retention fingers about a perimeter of the hollow body.

5. The grommet of claim 1 wherein:
the outer surface of the hollow body defines recesses configured to receive the panel retention fingers when the panel retention fingers flex toward the outer surface; and
the inner surface of the hollow body defines recesses configured to receive the stud retention fingers when the stud retention fingers flex toward the inner surface.

6. The grommet of claim 1 wherein:
the panel retention fingers flex about hinges disposed at or near a connection between the panel retention fingers and the hollow body and formed integral therewith; and
the stud retention fingers flex about hinges disposed at or near a connection between the stud retention fingers and the hollow body and formed integral therewith.

7. The grommet of claim 1 wherein the panel retention fingers define teeth configured to engage the bottom surface of the panel and thereby maintain the grommet in a fixed position within the hole in the panel.

8. The grommet of claim 1 wherein the stud retention fingers have ramped surfaces at distal ends thereof.

9. The grommet of claim 1 wherein portions of the hollow body form guide walls having tapered surfaces that engage the stud and thereby coaxially align the stud with the hole of the grommet as the stud is inserted therein.

10. A stud and grommet assembly comprising:
the grommet of claim 1; and
the stud, wherein the stud is configured to be coupled to a component so that the stud and grommet assembly couples the component to the panel when the stud is received in the hole in the grommet and the grommet is fixed within the hole in the panel.

11. The stud and grommet assembly of claim 10 wherein:
the stud includes a cylindrical body, at least one flange projecting radially outward from the cylindrical body, and the head; and
the head is disposed at one end of the cylindrical body.

12. The stud and grommet assembly of claim 11 wherein the at least one flange of the stud includes a pair of flanges that define a gap therebetween for receiving a flange of the component surrounding the hole therein.

13. The grommet of claim 12 wherein the stud includes an umbrella-shaped flange projecting from the flange of the stud closest to the head and configured to seal against the panel when the stud is fully inserted in the hole in the grommet and the grommet is fixed within the hole in the panel.

14. The stud and grommet assembly of claim 11 wherein:
the stud includes a threaded shank disposed at the other end of the cylindrical body and configured to be threaded into a threaded hole in the component to couple the stud to the component; and
the flange of the stud has a noncircular perimeter.

15. The grommet of claim 14 wherein the stud includes an umbrella-shaped flange projecting from the noncircular perimeter of the flange of the stud and configured to seal against the panel when the stud is fully inserted in the hole in the grommet and the grommet is fixed within the hole in the panel.

16. A stud and grommet assembly comprising:
a stud configured to be coupled to a component, the stud including a cylindrical body, at least one flange projecting radially outward from the cylindrical body, and a conical head disposed at one end of the cylindrical body; and
a grommet configured to be fixed within a hole in a panel, the grommet including a tubular body having an inner surface and an outer surface, an annular flange disposed at one end of the tubular body, panel retention fingers protruding from the outer surface of the tubular body, and stud retention fingers protruding from the inner surface of the tubular body, wherein:
the panel retention fingers are configured to flex radially inward toward the outer surface of the tubular body when the tubular body is inserted into the hole in the panel;
the panel retention fingers are configured to flex radially outward away from the tubular body and engage a bottom surface of the panel when the grommet is fully inserted into the hole in the panel so that the annular flange of the grommet engages a top surface of the panel;
the stud retention fingers are configured to flex radially outward toward the inner surface of the tubular body when the conical head of the stud is inserted into the hole in the grommet; and
the stud retention fingers are configured to flex radially inward away from the tubular body and engage an underside surface of the conical head of the stud when the stud is fully inserted into the hole in the grommet so that the at least one flange of the stud engages the annular flange of the grommet.

17. The stud and grommet assembly of claim 16 wherein the hole in the grommet extends completely through the grommet along a central longitudinal axis thereof.

18. The stud and grommet assembly of claim 16 wherein the annular flange of the grommet defines rectangular openings that are each aligned with one of the panel retention fingers about a circumference of the tubular body and disposed above that panel retention finger.

19. The stud and grommet assembly of claim 16 wherein the at least one flange of the stud includes a pair of disk-shaped flanges that define a gap therebetween for receiving a flange of the component surrounding the hole therein.

20. The stud and grommet assembly of claim 16 wherein:
the stud includes a threaded shank disposed at the other end of the cylindrical body and configured to be threaded into the hole in the component to couple the stud to the component; and
a perimeter of the at least one flange has a noncircular shape.
